(19) United States
(12) Patent Application Publication
(10) Pub. No.: US 2006/0177173 A1
(43) Pub. Date: Aug. 10, 2006

(54) Vertical stacking of multiple integrated circuits including SOI-based optical components

(75) Inventors: Kalpendu Shastri, Orefield, PA (US); Vipulkumar Patel, Breinigsville, PA (US); David Piede, Allentown, PA (US); John Fangman, Leesport, PA (US)

Correspondence Address: Wendy W. Koba, Esq., PO Box 556, Springtown, PA, 18081, US

(73) Assignee: Sioptical, Inc.

(21) Appl. No.: 11/346,718

(22) Filed: Feb. 3, 2006

Related U.S. Application Data
(60) Provisional application No. 60/650,061, filed on Feb. 4, 2005.

(51) Int. Cl. G02B 6/12; G02B 6/26; G02B 6/42; G02B 6/10

(52) U.S. Cl. 385/14; 385/129; 385/130; 385/131; 385/15; 385/31

(57) ABSTRACT

A vertical stack of integrated circuits includes at least one CMOS electronic integrated circuit (IC), an SOI-based opto-electronic integrated circuit structure, and an optical input/output coupling element. A plurality of metalized vias may be formed through the thickness of the stack so that electrical connections can be made between each integrated circuit. Various types of optical input/output coupling can be used, such as prism coupling, gratings, inverse tapers, and the like. By separating the optical and electrical functions onto separate ICs, the functionalities of each may be modified without requiring a re-design of the remaining system. By virtue of using SOI-based opto-electronics with the CMOS electronic ICs, a portion of the SOI structure may be exposed to provide access to the waveguiding SOI layer for optical coupling purposes.

### CROSS-REFERENCE TO RELATED APPLICATION

This application claims the benefit of US Provisional Application No. 60/650,061, filed Feb. 4, 2005.

### TECHNICAL FIELD

The present invention relates to a vertically stacked packaging arrangement for multiple integrated circuit chips and, more particularly, to a vertical stacking arrangement for use with SOI-based optical components and associated electronic integrated circuits.

### BACKGROUND OF THE INVENTION

Today's standard CMOS lithography design rules for electronic integrated circuits (ICs) utilize a linewidth of 90 nm, with the very likely possibility of being reduced going forward to 65 nm and below, perhaps down to a fine linewidth on the order of 22-32 nm (or less). While this finer linewidth photolithography is acceptable for electronic applications, it presents problems for silicon-on-insulator (SOI) applications that attempt to incorporate optical devices within the same structure as the electronics. In particular, the buried oxide in the SOI structure needs to be on the order of one micron in thickness for optical applications (for optical confinement reasons). However, having a one micron thick buried oxide layer causes significant bow to the wafer, particularly when compared to the planarity requirements for the very fine linewidth of advanced electronics. Additionally, the surface silicon layer in an SOI-based structure for fine line electronics will be extremely thin. This thinner layer causes the optical mode to be much larger than before, thus requiring an even thicker buried oxide layer for confinement purposes.

### SUMMARY OF THE INVENTION

The problems described above are addressed by the present invention, which relates to a vertically stacked packaging arrangement for multiple integrated circuit chips and, more particularly, to a vertical stacking arrangement for use with SOI-based optical components and associated electronic integrated circuits.

In accordance with the present invention, a vertical stack of integrated circuits includes at least one CMOS electronic integrated circuit (IC), an SOI-based opto-electronic structure, and an optical input/output coupling element. A plurality of metalized vias may be formed through the thickness of the stack so that electrical connections can be made between each integrated circuit. Various types of optical input/output coupling can be used, such as prism coupling, gratings, inverse tapers, three-dimensional adiabatic tapers and the like.

It is an aspect of the present invention that by separating the electrical components and opto-electronic components onto separate ICs, each can be optimized independently, while maintaining interconnection therebetween.

A further aspect of the present invention is the ability to provide straightforward optical access to the structure, by virtue of utilizing an optical input/output coupling element in intimate contact with the SOI-based opto-electronic circuit, even in the presence of relatively complex electronic and opto-electronic circuitry.

Other aspects and features of the present invention will become apparent during the course of the following discussion and by reference to the accompanying drawings.

### BRIEF DESCRIPTION OF THE DRAWINGS

Referring now to the drawings,

FIG. 1 illustrates, in a cut away side view, an exemplary vertical stack of CMOS-based electronics and SOI-based opto-electronics formed in accordance with the present invention;

FIG. 2 illustrates an alternative embodiment of the present invention, with the electrical bond pads formed directly on the SOI-based opto-electronic integrated circuit, and the terminations disposed on the underside of the electronic IC (suitable for connection to a printed wiring board);

FIG. 3 illustrates an exemplary optical clock arrangement formed with the vertical stack configuration of the present invention;

FIG. 4 is an isometric view of another embodiment of the present invention, in this case with the SOI-based opto-electronic integrated circuit disposed as the base layer in the vertical stack, and the optical input/output coupling element comprising a trapezoidal prism structure;

FIG. 5 contains an isometric view of an alternative to the embodiment of FIG. 4, in this case utilizing an optical grating as the optical input/output coupling element and a plurality of solder bumps used to provide electrical connections to the CMOS-based electronic circuit;

FIG. 6 illustrates a variation of the arrangement of FIG. 5, where the optical grating is replaced by an inverse taper optical coupler;

FIG. 7 contains a top view of an exemplary overall architecture of the vertical stack structure of the present invention; and

FIG. 8 is a cut-away side view of yet another embodiment of the present invention, in this case comprising multiple CMOS-based electronic ICs vertically stacked over the SOI-based opto-electronic IC.

### DETAILED DESCRIPTION

FIG. 1 illustrates, in a cut-away side view, an exemplary vertical stack arrangement formed in accordance with the present invention. As shown, the arrangement includes a first integrated circuit (IC) 10 comprising electronic circuitry, where IC 10 is fabricated using conventional CMOS processing techniques. Indeed, fine linewidth lithography as described above may be used to form the elements within IC 10. An SOI-based opto-electronic circuit 12 is disposed over electronic IC 10 in the manner shown in FIG. 1. As is well-known in the art, SOI-based circuit 12 includes a base silicon substrate 14, a buried oxide layer 16 and relatively thin silicon surface layer 18 (hereinafter referred to as an “SOI layer”). Although not particularly illustrated in FIG. 1 for the sake of clarity, this layer may include various doping regions and/or other sub-layers (such as polysilicon, interlevel dielectrics and metallizations) as required to form the desired passive and active optical devices. For this particular embodiment of the present invention, an evanescent coupling layer 20 is formed over SOI layer 18, where evanescent coupling layer 20 may comprise silicon dioxide. SOI-based circuit 12 is oriented such that silicon substrate 14 is disposed to contact electronic IC 10. An optical input/output (I/O) coupling element 22 is used in association with SOI-based circuit 12 to direct optical signals into and out of SOI layer 18. In certain embodiments of the present invention, optical I/O coupling element 22 is formed as an integral part of SOI-based circuit 12 (i.e., features directly formed in SOI layer 18). In other cases, optical I/O coupling element 22 may comprise a separate, discrete component (e.g., optical prism).

In the particular arrangement as shown in FIG. 1, an electrical signal coupling area 24, comprising a plurality of bond pad sites 28, is formed within optical (I/O) coupling element 22 and used to provide connection to electronic IC 10, as described in the following. Each bond pad 28 is coupled through an associated metallized via 30 to a bond pad 32 formed on the top surface 34 of SOI-based circuit 12. In an alternative arrangement of this embodiment, the portion of optical I/O coupling element 22 in the region of electrical connection may be removed, allowing for direct access to bond pads 32. Referring back to the particular embodiment of FIG. 1, a plurality of metallized vias 36 are formed through the complete thickness of SOI-based circuit 12, terminating at a plurality of contacts 38 formed on top surface 40 of electronic IC 10. Various techniques, well-known in the art, may be used to form the vias through the plurality of layers within the silicon-based structure and also IC packaging technologies for chip/wafer stacking. It is an aspect of the present invention that by using a CMOS-compatible structure for the opto-electronic circuit (that is, SOI-based circuit 12), it is relatively straightforward to form electrical contacts and vias during the same processing steps as used to form the passive and active optical devices.

In the particular embodiment of FIG. 1, optical I/O coupling element 22 is seen to comprise a pair of prism couplers 42 and 44. In this arrangement, an optical input signal I is directed through input prism coupler 42, where the beam is properly refracted by prism coupler 42 and evanescent coupling layer 20 into SOI layer 18. A complete description of prism coupling into SOI-based structures may be found in US Published Application 2004/0190826 assigned to the assignee of the present application. As mentioned above, various other techniques for providing optical coupling into an SOI structure may be used as optical I/O coupling element 22, where these alternative techniques are also compatible with CMOS processing techniques and may be easily be formed within a silicon substrate. For example, a grating structure may be etched into SOI-based circuit 12, where the grating pitch and period are controlled to provide the optical coupling. Alternatively, an inverse taper structure or a three-dimensional adiabatic horn taper element may be used to couple an optical signal from a fiber or optical device/waveguide into SOI layer 18.

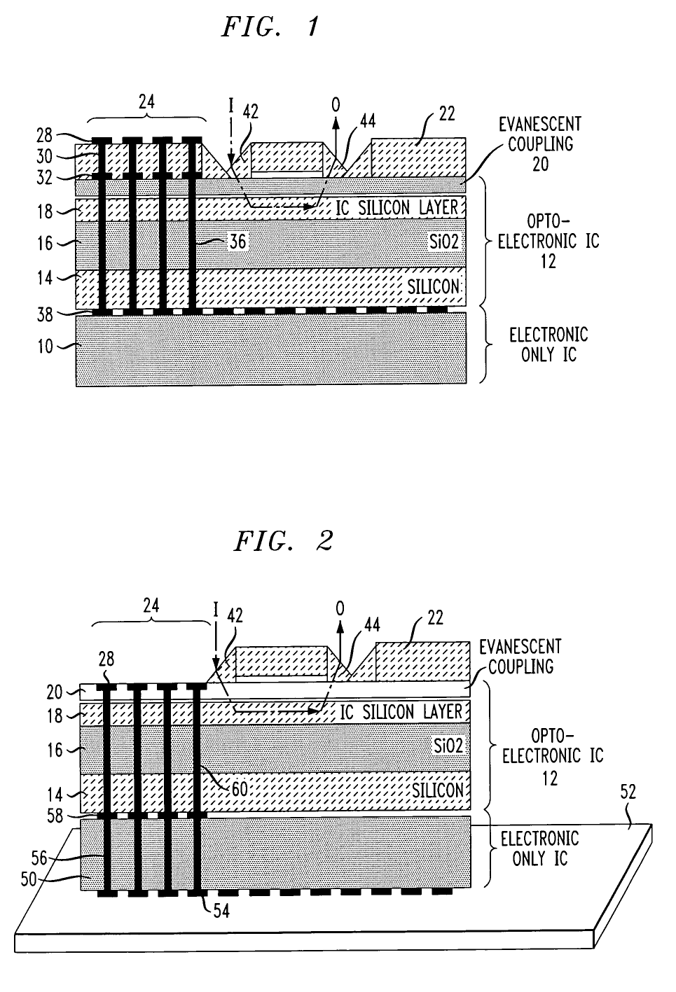

FIG. 2 illustrates an alternative embodiment of the present invention, utilizing a different electrical contact arrangement. Referring to FIG. 2, the stack arrangement is the same as that of FIG. 1, with electronic IC 10 as the bottom layer, SOI-based opto-electronic IC 12 in the middle and optical I/O coupling element 22 disposed over SOI-based opto-electronic IC 12. In contrast to the arrangement of FIG. 1, the electrical interconnection is provided through a bottom surface 50 of electronic IC 10. In this arrangement, electrical contact can then be made to, for example, a printed wiring board 52. As shown, a plurality of bond pads 54 are formed on bottom surface 50 and properly arranged to contact the desired locations on printed wiring board 52. A plurality of vias 56 are shown as formed through the thickness of electronic IC 10, terminating in a plurality of electrical contacts 58. A plurality of vias 60 are disposed through the thickness of SOI-based circuit 12, terminating at evanescent coupling layer 20. The presence of the electrical connection to SOI-based circuit 12 is required to allow for active optical devices, such as modulators, switches and the like, to be controlled by using an electrical signal to provide free carrier modulation within the optical devices.

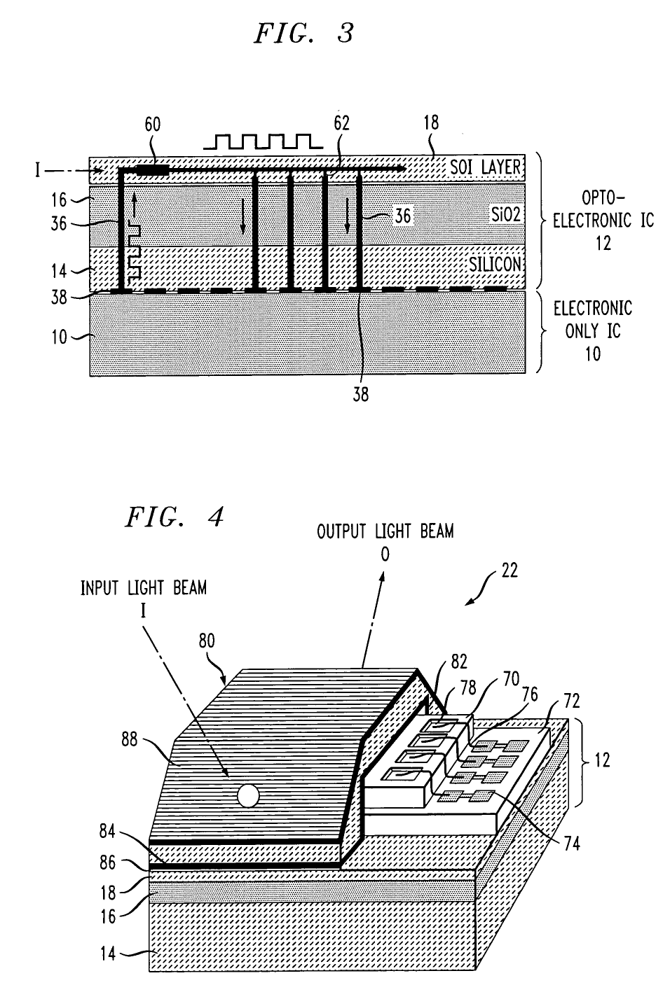

Today's silicon ICs utilize clocking signals at speeds of 10 GHz and above. As these speeds increase to 20 GHz and beyond, electrical transmission lines become problematic. For example, a 40 GHz clock distribution system has a quarter wavelength of approximately 5 mm in silicon. To distribute this clock signal requires the use of load termination resistors to reduce reflections and ensure proper operation, significantly increasing the power dissipation of the IC. One solution, as illustrated in FIG. 3, is to utilize optical signal paths to distribute the clock signal.

FIG. 3 illustrates a vertically stacked arrangement similar to that of FIG. 1. In this arrangement, an electrical clock signal is created on electronic IC 10 and is available for transmission at bond pad 38. The electrical clock signal then propagates in the vertical direction along via 36 into SOI layer 18. There, an electrical/optical converting device 60 (such as an optical modulator) uses a propagating CW optical signal to convert the electrical clock signal into an optical clock signal for distribution through SOI layer 18. As shown, a plurality of O/E taps 62 (such as photodiodes) are distributed at predetermined locations along SOI layer 18 and used to out-couple a portion of the propagating optical clock signal and re-convert the signal into its electrical form. The electrical clock signal is then transmitted through vias 36 and back into electronic IC 10 at bond pad sites 38. Of course, such an arrangement may be used to distribute various types of high speed signals across electronic IC 10, such as clock and data information signals.

FIG. 4 illustrates, in an isometric view, a different embodiment of the present invention. In this particular embodiment, SOI-based IC 12 is utilized as the “base” of the stack, with an electronic IC 70 disposed over SOI-based IC 12. In this embodiment, SOI-based IC 12 further comprises a conventional multi-layer dielectric/metallization stack 72, grown/deposited over SOI layer 18 and used to facilitate access to electrical connections on electronic IC 70. In particular, a plurality of bond pad sites 74 are disposed along the periphery of the top layer of stack 72 to contact to external signal/power leads. A plurality of wirebonds 76 are then used in this embodiment to provide electrical signal paths to a plurality of electrical contact areas 78 formed on electronic IC 70 as shown. Alternatively, a plurality of flip-chip solder bumps, or any other type of low temperature bonding arrangement well-known in the art may be used to form the mechanical/electrical connection between electronic IC 70 and bond pad sites 74, for example, polymer bonding, low temperature plasma-activated direct bonding, eutectic bonding, and the like.

In this particular embodiment, optical I/O coupling element 22 comprises a trapezoidal prism coupler 80 disposed in the manner illustrated in FIG. 4, where in a preferred embodiment, trapezoidal prism coupler 80 comprises silicon. As shown, trapezoidal prism coupler 80 is configured so that electronic IC 70 is “housed” within a cavity 82 formed in the underside 84 of trapezoidal prism coupler 80, while still allowing access to bond pad sites 74. In order to provide satisfactory coupling of an incoming optical signal into SOI layer 18, the portion of stack 72 in the vicinity of the optical coupling region is removed (so as to “open” a window to SOI layer 18) and a relatively thin evanescent coupling layer 86 is formed to cover underside 84 of trapezoidal prism coupler 80. Preferably, an anti-reflective coating 88 is disposed over the exposed top surface of trapezoidal prism coupler 80.

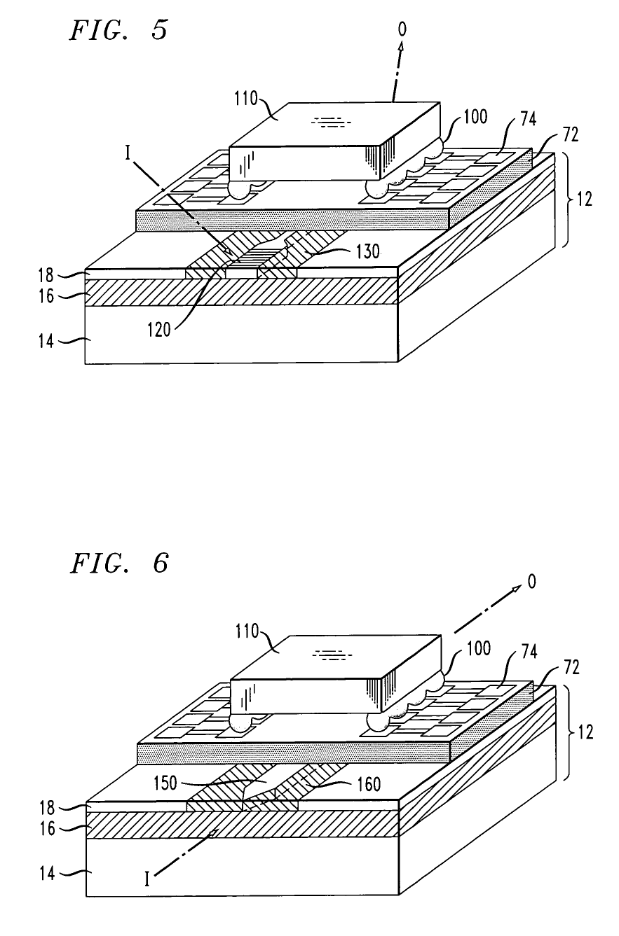

FIG. 5 illustrates an alternative to the embodiment of FIG. 4, where in this case a set of flip-chip solder bumps 100 is used to provide electrical connection between an electronic IC 110 and stack 72. In place of trapezoidal prism coupler 80, the embodiment of FIG. 5 utilizes a pair of separate optical gratings, a first grating 120 for coupling a free space optical signal into SOI layer 18 and a second grating (not shown) for out-coupling a propagating optical signal from SOI layer 18. In this case, the gratings are directly formed within SOI layer 18, with surrounding low index confinement regions 130 used to direct the propagating optical signal along SOI layer 18. The depth of the grating features and the period of the grating structure are designed so as to most efficiently couple the wavelength of the propagating signal. In one exemplary embodiment, an adiabatic grating structure may be used to preserve the mode of the propagating signal. Silicon dioxide may be used for confinement regions 130.

FIG. 6 illustrates a variation of the embodiment of FIG. 5, where in this case, optical I/O coupling element 22 comprises an inverse taper structure 150 formed within SOI layer 18. An optical confinement region 160 (such as a low index dielectric material) is formed to surround inverse taper structure 150. As with the grating described above, an adiabatic geometry may be used to preserve the mode of the propagating signal. The embodiment as shown in FIG. 6 is particularly well-suited for coupling into/out of an optical fiber (or any other type of optical device) disposed coaxially with optical path in the vertically stacked structure.

It is to be understood that the input and output couplers may comprise different structures, depending on the application.. For example, the input coupling may be from a laser or an optical fiber, while the output from the SOI layer 18 may be coupled into a fiber or detector. Moreover, it is advantage of the arrangement of the present invention that the use silicon technology allows for various alignment features (V-grooves, fiducials and the like) to be formed within optical I/O element 22 and provide accurate passive alignment between the input/output optics and SOI layer 18.

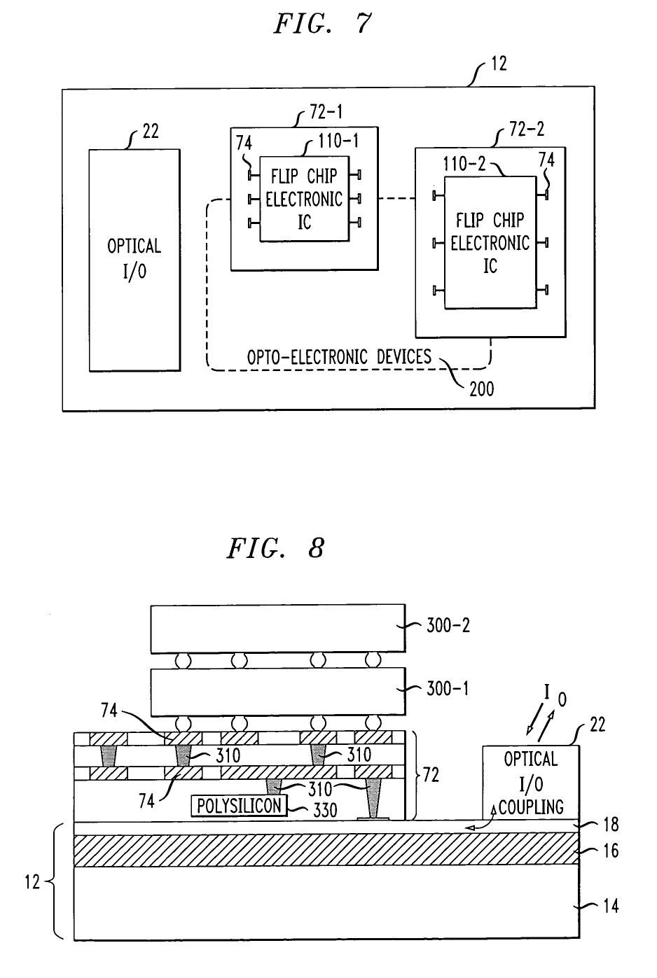

FIG. 7 shows, in a top view, an overall architecture of the various components in the vertically stacked arrangement of the present invention. In this case, SOI-based IC 12 is used as the base integrated circuit, with optical I/O coupling element 22 disposed at a predetermined location on SOI layer 18 of SOI-based IC 12. Optical I/O coupling element 22 may comprise, as discussed above, a prism coupling structure, a grating coupling, inverse taper coupling arrangement, three-dimensional adiabatic horn taper or any other suitable structure for coupling a propagating optical signal into and out of SOI layer 18. It is an advantage of the arrangement of the present invention that the vertically stacked combination of SOI-based opto-electronic IC 12 with various CMOS-based electronic ICs provides direct access to the optical coupling area (i.e., SOI layer 18), thus simplifying the process of bringing optical, as well as electrical, signals to the structure.

In the particular architecture as shown in FIG. 7, the photonic and electronic components formed within SOI-based IC 12 (for example, waveguides, modulators, switches, resonators, drivers, detectors and the like) are disposed within an area 200 that is coupled (in a manner not shown) to receive optical signals from optical I/O element 22. In accordance with the present invention, at least one electronic IC 110 is situated in a stacked configuration with SOI-based IC 12, with electrical contacts formed to bond pad sites 74 of underlying multi-layer stack 72, as shown in FIGS. 6 and 7. As shown in FIG. 7, separate electronic ICs 110-1 and 110-2 may be contacted to photonic functions area 200, each supported by a separate portion of stack 72-1 and 72-2, respectively. Indeed, any desired number of separate electronic ICs may be positioned over SOI-based IC 12. The ability to attach more than one electronic IC allows for flexibility in the functionality of the entire opto-electronic system, as well as allows for modifications to be easily made in the various electrical requirements for the system. For example, one electronic IC may comprise a memory element, another a transimpedance amplifier or a driver module, etc. Moreover, the use of separate electronic ICs in a stacked configuration with SOI-based IC 12 is that the electronics may take advantage of state-of-the-art developments in IC processing technology, and can allow for a “mix” of different technologies (for example, bulk CMOS, BiCMOS, fully-depleted SOI, partially-depleted SOI, strained silicon CMOS, SiGe CMOS and various memory processes) to be used within the same stack so as to optimize the performance of the individual ICs. Therefore, as one technology advances, the remaining components do not have to be re-engineered, saving development and fabrication expenses, as well as reducing time to market for the improved arrangements.

FIG. 8 illustrates, in a cut-away side view, a variation of the architecture of FIG. 7, where in this example multiple electronic ICs 300-1 and 300-2 are themselves stacked in a vertical configuration, with electronic IC 300-1 disposed over and electrically bonded to bond pad sites 74 of stack 72. While only two such electronic ICs 300 are shown, it is to be understood that any required number of separate electronic ICs may be used. Alternatively, a combination of the arrangements of FIGS. 7 and 8 may be used. Referring to FIG. 8, a plurality of metallized vias 310 are used to interconnect various specific bond pad sites 74, as well as provide a terminating connection to SOI layer 18 or an intermediate region 330 (such as polysilicon or a doped silicon area). As is known in the art, the addition of a polysilicon layer to an SOI-based optical structure allows for enhanced manipulation of an optical signal propagating through the structure. As shown, optical I/O coupling element is situated at a separate location, in this case disposed over a portion of exposed SOI layer 18. Thus, even though the arrangement of FIG. 8 comprises a relatively complicated combination of electronics and opto-electronics, the optical interface remains relatively simple to implement.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed is:

1. A vertically stacked arrangement of a plurality of integrated circuits, the arrangement comprising
a silicon-on-insulator (SOI)-based opto-electronic integrated circuit comprising at least a silicon substrate, an intermediate dielectric layer and a relatively thin silicon surface layer (SOI layer), with active and passive optical devices formed in at least the SOI layer;
at least one silicon-based electronic integrated circuit disposed to vertically stack with the SOI-based opto-electronic integrated circuit and provide electrical control signals thereto; and
an optical input/output coupling element disposed in conjunction with the SOI layer of the vertically stacked arrangement to couple optical signals into and out of the SOI-based opto-electronic integrated circuit.

2. The vertically stacked arrangement as defined in claim 1 wherein the optical input/output coupling element comprises a prism coupling element.

3. The vertically stacked arrangement as defined in claim 1 wherein the optical input/output coupling element comprises an optical grating for coupling signals into and out of the SOI layer.

4. The vertically stacked arrangement as defined in claim 1 wherein the optical input/output coupling element comprises an inverse taper coupling arrangement.

5. The vertically stacked arrangement as defined in claim 1 wherein the optical input/output coupling element comprises a three-dimensional adiabatically contoured coupling element to maintain the mode of the propagating optical signal.

6. The vertically stacked arrangement as defined in claim 1 wherein the plurality of integrated circuits are stacked such that the at least one silicon-based electronic integrated circuit is disposed as a bottom layer of the stack, with the SOI-based opto-electronic integrated circuit disposed over said at least one silicon-based electronic integrated circuit.

7. The vertically stacked arrangement as defined in claim 6 wherein a first plurality of metallic contacts is disposed on a top surface of the SOI-based opto-electronic integrated circuit and a second plurality of metallic contacts is disposed on a top surface of the at least one silicon-based electronic integrated circuit, with a plurality of metallized vias formed through the thickness of the SOI-based opto-electronic integrated circuit, the combination of the metallic contacts and metallized vias forming electrical signal paths through said vertically stacked arrangement.

8. The vertically stacked arrangement as defined in claim 6 wherein the SOI-based opto-electronic circuit is flip-chip bonded to the at least one silicon-based electronic integrated circuit.

9. The vertically stacked arrangement as defined in claim 6 wherein a plurality of metallic contacts are formed on a bottom surface of the at least one silicon-based electronic integrated circuit and a plurality of associated metallized vias are formed through the thickness of the at least one silicon-based electronic integrated circuit and the SOI-based opto-electronic circuit, the combination providing electrical signal paths through the vertically stacked arrangement.

10. The vertically stacked arrangement as defined in claim 9 wherein the plurality of metallic contacts on the bottom surface of the at least one silicon-based electronic integrated circuit are disposed to contact an associated printed wiring board.

11. The vertically stacked arrangement as defined in claim 1 wherein the plurality of integrated circuits are stacked such that the SOI-based opto-electronic circuit is disposed as the bottom, support integrated circuit, with the at least one silicon-based electronic integrated circuit and the optical input/output coupling element disposed at separate locations over the SOI layer of the SOI-based opto-electronic integrated circuit, the stacked arrangement further comprising a multi-layer dielectric/metal stack formed between the SOI layer and the at least one silicon-based electronic integrated circuit, the stack including a plurality of bond pads for providing electrical connections to external sources.

12. The vertically stacked arrangement as defined in claim 11 wherein the at least one silicon-based electronic integrated circuit is flip-chip bonded to the bond pads of the multi-layer stack.

13. The vertically stacked arrangement as defined in claim 11 wherein the at least one silicon-based electronic integrated circuit is wirebonded to the bond pads of the multi-layer stack.

14. The vertically stacked arrangement as defined in claim 11 wherein the at least one silicon-based electronic integrated circuit is attached to the SOI-based opto-electronic integrated circuit using a process selected from the group of: polymer bonding, low temperature plasma-activated direct bonding, eutectic bonding.

15. The vertically stacked arrangement as defined in claim 11 wherein the at least one silicon-based electronic integrated circuit comprises a plurality of separate silicon-based electronic integrated circuits.

16. The vertically stacked arrangement as defined in claim 15 wherein the plurality of silicon-based electronic integrated circuits are disposed at different locations over the surface of the SOI-based opto-electronic integrated circuit.

17. The vertically stacked arrangement as defined in claim 15 wherein the plurality of silicon-based electronic integrated circuits are disposed in a vertically stacked configuration over the dielectric layer.
